(19) United States
(12) Patent Application Publication
(10) Pub. No.: US 2010/0218209 A1
(43) Pub. Date: Aug. 26, 2010

(54) Apparatus having an emergency alert function that facilitates location selection

(76) Inventor: Scott Allan Kendall, Westfield, IN (US)

Correspondence Address: Robert D. Shedd, Patent Operations;THOMSON Licensing LLC, P.O. Box 5312, Princeton, NJ, 08543-5312, US

(21) Appl. No.: 11/921,988

(22) PCT Filed: Jun. 21, 2005
(86) PCT No.: PCT/US2005/021737

§ 371 Date: Dec. 10, 2007

(51) Int. Cl. H04N 7/025; G08B 3/10

(52) U.S. Cl. 725/33; 340/311.2

(57) ABSTRACT

An apparatus (20) such as a television signal receiver, radio or other device provides an emergency alert function that facilitates user selection of geographical locations to ensure proper notification of emergency events. According to an exemplary embodiment, the apparatus (20) includes a memory (27) operative to store data that enables a setup process of the emergency alert function. A processor (27) is operatively coupled to the memory (27). The processor (27) is operative to use the data to enable display of a first list including a plurality of locations. The processor (27) receives a first user input selecting a first one of the locations. The processor (27) identifies at least one transmitter (10) serving the first location and enables display of a second list responsive to the first user input. The second list includes at least one of the locations served by the at least one transmitter (10) other than the first location, and does not include the locations not served by the at least one transmitter (10).

The present invention generally relates to apparatuses such as television signal receivers, radios or other apparatuses having an emergency alert function, and more particularly, to an apparatus and method for providing an emergency alert function that facilitates user selection of geographical locations to ensure proper notification of emergency events.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain apparatuses are capable of receiving emergency alert signals provided by sources such as the NWS and NOAA, and provide an emergency alert function using Specific Area Message Encoding (SAME) technology. Apparatuses using SAME technology typically require a user to perform a setup process for the emergency alert function by selecting items including one or more geographical locations of interest, and one or more types of emergency events which activate the emergency alert function. Once the setup process is complete, the emergency alert function may be activated when incoming emergency alert signals including SAME data indicate the occurrence of an emergency event which corresponds to the geographical location(s) and types of emergency event selected by the user during the setup process. When the emergency alert function is activated, an alert output such as an audio and/or visual message may be provided to alert individuals of the emergency event.

With conventional apparatuses having an emergency alert function using SAME technology, the aforementioned setup process for the emergency alert function can be problematic for users. In particular, users may select certain geographical locations and be given the false impression that they will actually receive notification of emergency events in those locations. For example, users may select locations in far away places with the desire to receive notification of emergency events in those locations. However, given that NOAA transmitters broadcast emergency alert signals to only a limited range of locations, users may never receive notification of emergency events in certain selected locations.

Accordingly, there is a need for an apparatus and method for providing an emergency alert function that addresses the foregoing problem, and thereby facilitates user selection of geographical locations to ensure proper notification of emergency events. The present invention addresses these and/or other issues.

In accordance with an aspect of the present invention, an apparatus having an emergency alert function is disclosed. According to an exemplary embodiment, the apparatus comprises memory means for storing data that enables a setup process of the emergency alert function. Processing means uses the data to enable display of a first list including a plurality of locations. The processing means receives a first user input selecting a first one of the locations. The processing means identifies at least one transmitter serving the first location and enables display of a second list responsive to the first user input. The second list includes at least one of the locations served by the at least one transmitter other than the first location, and does not include the locations not served by the at least one transmitter.

In accordance with another aspect of the present invention, a method for providing a setup process for an emergency alert function of an apparatus is disclosed. According to an exemplary embodiment, the method comprises steps of enabling display of a first list including a plurality of locations, receiving a first user input selecting a first one of the locations, identifying at least one transmitter serving the first location responsive to the first user input, enabling display of a second list responsive to the first user input, and wherein the second list includes at least one of the locations served by the at least one transmitter other than the first location, and does not include the locations not served by the at least one transmitter.

In accordance with yet another aspect of the present invention, a television signal receiver having an emergency alert function is disclosed. According to an exemplary embodiment, the television signal receiver comprises a memory operative to store data that enables a setup process of the emergency alert function. A processor is operatively coupled to the memory. The processor is operative to use the data to enable display of a first list including a plurality of locations. The processor receives a first user input selecting a first one of the locations. The processor identifies at least one transmitter serving the first location and enables display of a second list responsive to the first user input. The second list includes at least one of the locations served by the at least one transmitter other than the first location, and does not include the locations not served by the at least one transmitter.

The above-mentioned and other features and advantages of this invention, and the manner of attaining them, will become more apparent and the invention will be better understood by reference to the following description of embodiments of the invention taken in conjunction with the accompanying drawings, wherein:

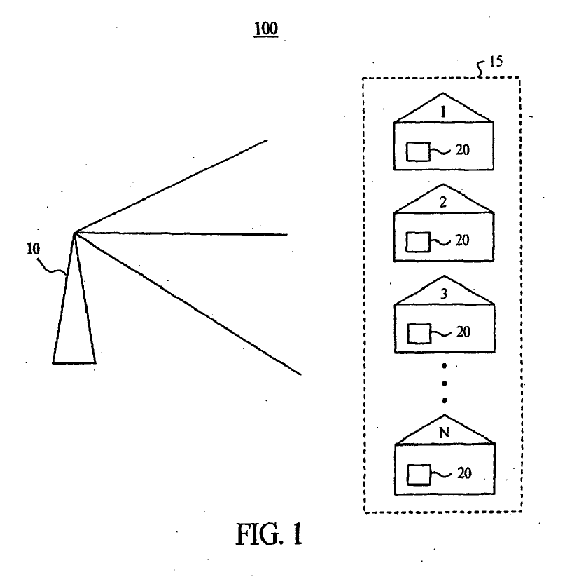

FIG. 1 is an exemplary environment suitable for implementing the present invention;

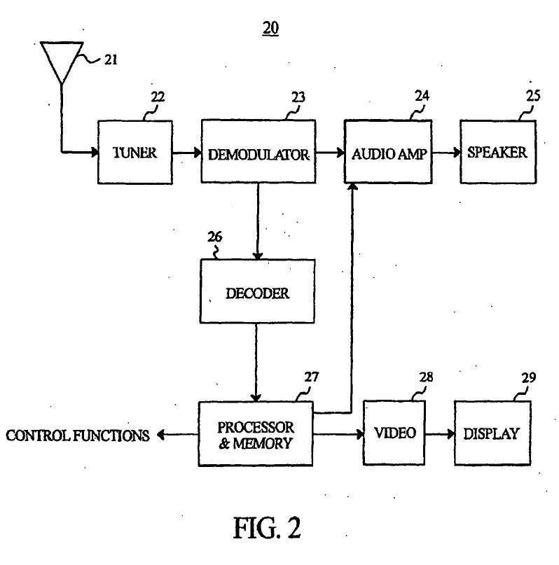

FIG. 2 is a block diagram of an apparatus having an emergency alert function according to an exemplary embodiment of the present invention;

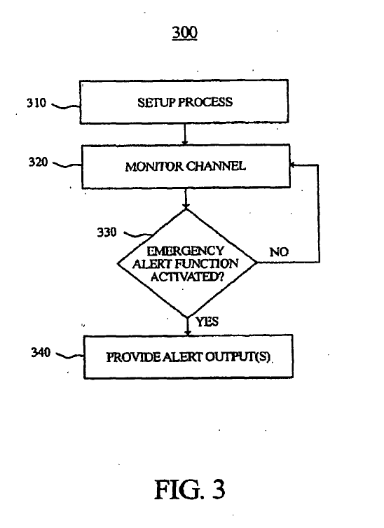

FIG. 3 is a flowchart illustrating exemplary steps for providing an emergency alert function;

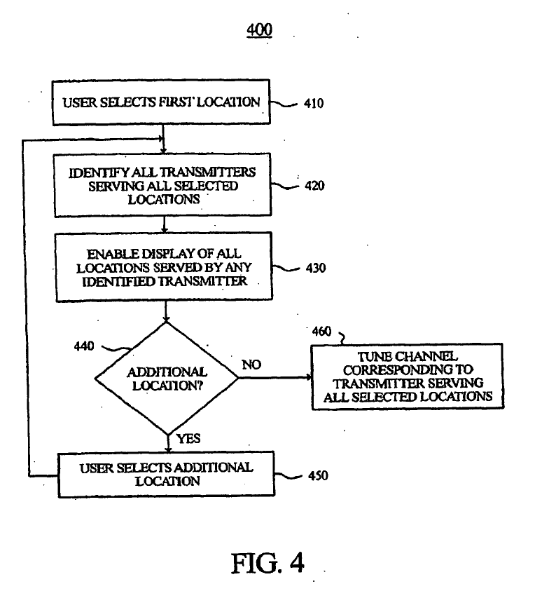

FIG. 4 is a flowchart illustrating steps for facilitating user selection of geographical locations according to an exemplary embodiment of the present invention;

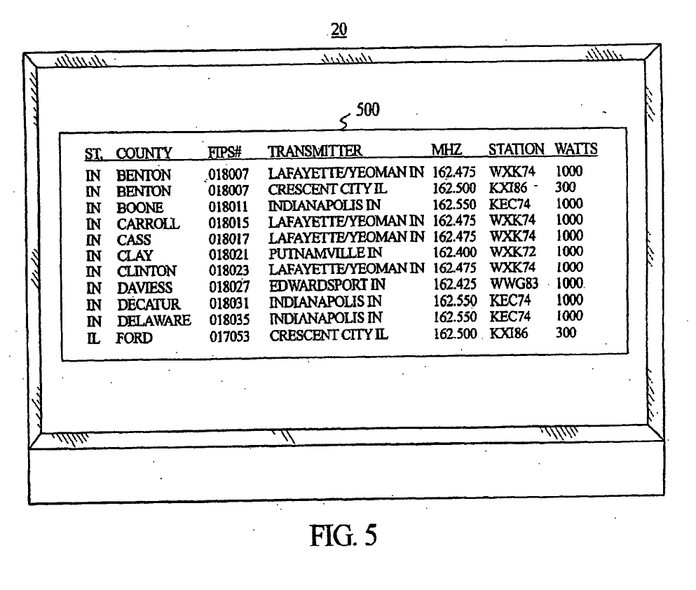

FIG. 5 is an exemplary on-screen menu suitable for use when practicing the steps of FIG. 4;

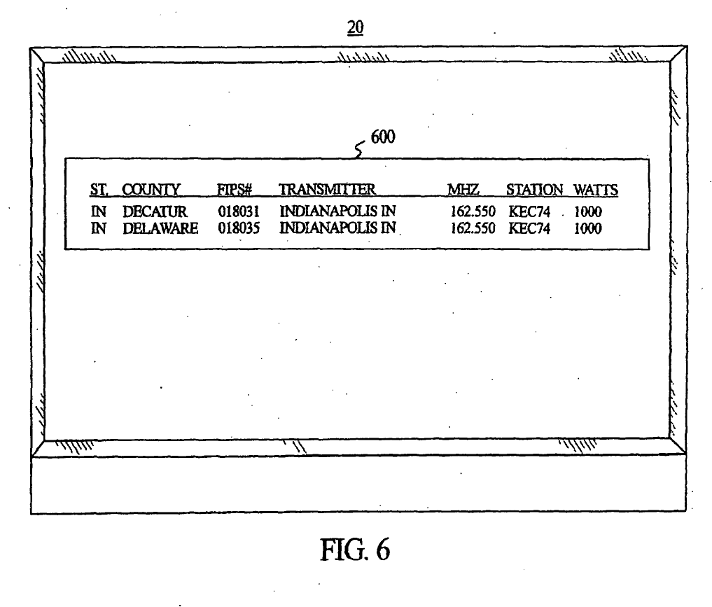

FIG. 6 is another exemplary on-screen menu suitable for use when practicing the steps of FIG. 4; and

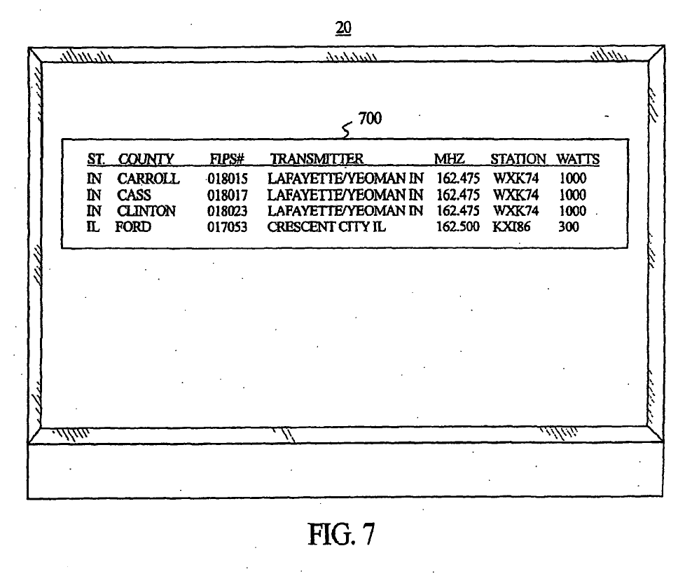

FIG. 7 is yet another exemplary on-screen menu suitable for use when practicing the steps of FIG. 4.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as one or more signal transmitters 10, dwelling means such as dwelling units 15 (i.e., 1, 2, 3 . . . N, where N may be any positive integer), and signal receiving means such as apparatuses 20.

In FIG. 1, dwelling units 15 may represent residences, businesses and/or other dwelling places located within a particular geographical location, such as but not limited to, a particular continent, country, region, state, area code, zip code, city, county, municipality, subdivision, and/or other definable geographical location. According to an exemplary embodiment, each of the dwelling units 15 is equipped with at least one apparatus 20 having an emergency alert function. Apparatus 20 may be embodied as any type of apparatus having an emergency alert function such as a television signal receiver, radio, or other apparatus. According to the present invention, the emergency alert function enables, among other things, apparatus 20 to receive emergency alert signals and provide one or more alert outputs to notify individuals of an emergency event.

According to an exemplary embodiment, signal transmitter(s) 10 transmit signals including audio, video and/or emergency alert signals which may be received by each apparatus 20. Each of the one or more signal transmitters 10 broadcasts such signals to only a limited range of geographical locations. According to an exemplary embodiment, the emergency alert signals may be provided from an authority such as the NWS, or other authorities such as governmental entities or the like. Signal transmitters) 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each apparatus 20 may provide one or more alert outputs to thereby notify individuals of the emergency event. Signal transmitter(s) 10 may transmit signals to apparatuses 20 via any wired and/or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of apparatus 20 of FIG. 1 is shown. In FIG. 2, apparatus 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements associated with apparatus 20 such as certain control signals, power signals and/or other elements may not be shown in FIG. 2.

Signal receiving element 21 is operative to receive signals including audio, video and/or emergency alert signals from signal sources, such as signal transmitter(s) 10 in FIG. 1. According to an exemplary embodiment, received audio signals may include digitally encoded emergency alert signals. According to another exemplary embodiment, emergency alert signals may be received as separate data packets in a digital transmission system. Signal receiving element 21 may be embodied as any signal receiving element such as an antenna, input terminal or other element.

Tuner 22 is operative to tune channels that provide signals including audio, video and/or emergency alert signals. According to an exemplary embodiment, tuner 22 is capable of tuning channels corresponding to at least the following designated NWS frequencies: 162.400 MHz, 162.425 MHz, 162.450 MHz, 162.475 MHz, 162.500 MHz, 162.525 MHz and 162.550 MHz. Such channels may provide audio signals that include digitally encoded emergency alert signals. Tuner 22 may also tune other frequency channels including those used in terrestrial, cable, satellite and/or other transmissions.

Demodulator 23 is operative to demodulate signals provided from tuner 22, and may demodulate signals in analog and/or digital transmission formats. According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to one or more control signals provided from processor 27. Speaker 25 is operative to aurally output the amplified audio signals provided from audio amplifier 24.

Decoder 26 is operative to decode signals including audio, video and/or emergency alert signals. According to an exemplary embodiment, decoder 26 decodes audio signals to thereby extract digitally encoded frequency shift keyed FSK) signals, which represent emergency alert signals indicating an emergency event. Decoder 26 may also perform other decoding functions, such as decoding data which represents emergency alert signals included in the vertical blanking interval (VBI) of an analog television signal.

According to an exemplary embodiment, the emergency alert signals include data comprising SAME data associated with the emergency event. SAME data comprises a digital code representing information such as the specific geographical location affected by the emergency event, the type of emergency event (e.g., tornado watch, radiological hazard warning, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of apparatus 20. According to an exemplary embodiment, processor 27 receives the emergency alert signals from decoder 26 and determines whether the emergency alert function of apparatus 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of apparatus 20 allows a user to select items such as an applicable geographical location(s), and type(s) of emergency events (e.g., tornado watch, radiological hazard warning, civil emergency, etc.) which activate the emergency alert function.

When the emergency alert function of apparatus 20 is activated, processor 27 outputs one or more control signals which enable various operations. According to an exemplary embodiment, such control signals enable one or more alert outputs (e.g., aural and/or visual) to thereby notify individuals of the emergency event. Such control signals may also enable other operations of apparatus 20, such as causing it to be switched from an off/standby mode to an on mode.

Processor and memory 27 are also operative to perform and/or enable other operations associated with the emergency alert function of apparatus 20. According to the present invention, processor 27 is operative to perform and/or enable steps for facilitating user selection of geographical locations during the aforementioned setup process of the emergency alert function. Memory 27 is operatively coupled to processor 27 and stores data that enables the setup process of the emergency alert function. According to an exemplary embodiment, processor 27 uses the data stored in memory 27 to enable *display of a first list including a plurality of locations during the setup process. A user may then select a first location from the first list via a user input to apparatus 20 (e.g., using a remote control device not shown in FIGS.) which is received by processor 27. In response to this user input, processor 27 uses data stored in memory 27 to identify at least one signal transmitter 10 (see FIG. 1) serving the first location and enable display of a second list. This second list includes at least one of the locations served by the at least one signal transmitter 10 other than the first location, and does not include those locations not served by the at least one signal transmitter 10. Also according to an exemplary embodiment, processor 27 is operative to detect the signal strength on channels tuned by tuner 22, and enable output of a predetermined message if the detected signal strength is below a predetermined threshold level. Further details regarding the aforementioned aspects of the present invention will be provided later herein.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays.

Display 29 is operative to provide visual displays. According to an exemplary embodiment, display 29 may provide visual displays including the aforementioned messages that provide details regarding emergency events. Display 29 may also include a viewable display panel having one or more indicator elements such as light emitting diodes (LEDs), liquid crystal display (LCD) elements, liquid quartz display (LQD) elements, and/or other elements. Such indicator elements may include highlighted indicators, such as monochrome and/or colored indicators, plasma display indicators, and/or conventional lights used as consumer electronic product indicators, and may for example reside apart from apparatus 20, such as on a portable (e.g., non-tethered) lighted panel designed for a wall and/or desk display. This may also allow various LED, LCD, LQD, plasma and/or cathode ray tube (CRT) devices to incorporate indicator elements for the emergency alert function as the total visual data field or a portion thereof. For example, the indicator elements may be highlighted as a portion of the visual data being displayed on an LCD panel playing recorded video content, such as content from a digital versatile disk (DVD) or the like.

Turning now to FIG. 3, a flowchart 300 illustrating exemplary steps for providing an emergency alert function is shown. For purposes of example and explanation, the steps of FIG. 3 will be described with reference to apparatus 20 of FIG. 2. The steps of FIG. 3 are merely exemplary, and are not intended to limit the present invention in any manner.

At step 310, a setup process for the emergency alert function of apparatus 20 is performed. According to an exemplary embodiment, a user performs this setup process by providing inputs to apparatus 20 (e.g., using a remote control device not shown in FIGS.) responsive to on-screen menus displayed via display 29. According to an exemplary embodiment, the user may select at least the following items during the setup process at step 310:
A. Enable/Disable—The user may select whether to enable or disable the emergency alert function.
B. Geographical Locations—The user may select one or more geographical locations of interest. For example, the user may select a particular continent, country, region, state, area code, zip code, city, county, municipality, subdivision, and/or other definable geographical location. According to an exemplary embodiment, such geographical location(s) may be represented by location codes, such as Federal Information Processing Standard (FIPS) location codes. The present invention facilitates user selection of geographical locations to ensure proper notification of emergency events. The present invention also selects a channel to be monitored for emergency alert signals based on the user's selection of one or more geographical locations. Further details regarding the selection of geographical locations and a monitoring channel will be provided later herein with reference to FIG. 4.
C. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.
D. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune apparatus 20 to a specific channel. The user may also for example select to aurally output a warning tone (e.g., chime, siren, etc.) and/or an audio message (e.g., NWS audio message), and the desired volume of each. Other types of alert outputs may also be provided according to the present invention.

According to the present invention, other menu selections may also be provided at step 310 and/or some of the menu selections described above may be omitted. Data corresponding to the user's selections during the setup process of step 310 is stored in memory 27.

At step 320, apparatus 20 monitors a particular channel via tuner 22 to thereby receive emergency alert signals. According to an exemplary embodiment, apparatus 20 is capable of monitoring a channel and receiving emergency alert signals during all modes of operation, including for example when apparatus 20 is turned on, turned off, and/or during playback of recorded audio and/or video content.

At step 330, a determination is made as to whether the emergency alert function of apparatus 20 is activated. According to an exemplary embodiment, processor 27 makes this determination by comparing data included in the incoming emergency alert signals to data stored in memory 27. As previously indicated herein, the emergency alert signals may include data such as SAME data which represents information including the type of emergency event (e.g., tornado watch, radiological hazard warning, civil emergency, etc.) and the specific geographical location(s) affected by the emergency event. According to an exemplary embodiment, processor 27 compares this SAME data to corresponding user setup data (i.e., items B and C of step 310) stored in memory 27 to thereby determine whether the emergency alert function is activated. In this manner, the emergency alert function of apparatus 20 is activated when the emergency event indicated by the emergency alert signals corresponds to: (1) any geographical location(s) selected by the user for item B of step 310 and (2) any event type(s) selected by the user for item C of step 310.

If the determination at step 330 is negative, process flow loops back to step 320 where tuner 22 continues to monitor the channel for emergency alert signals. Alternatively, if the determination at step 330 is positive, process flow advances to step 340 where apparatus 20 provides one or more alert outputs to thereby notify individuals of the emergency event.

According to an exemplary embodiment, processor 27 enables the one or more alert outputs at step 340 in accordance with the user's selections during the setup process of step 310 (i.e., item D), and such alert outputs may be aural and/or visual in nature. For example, aural outputs such as a warning tone and/or an NWS audio message may be provided at step 340 via speaker 25, and the volume of such aural outputs may be controlled in accordance with the volume level set by the user during the setup process of step 310. Visual outputs may also be provided at step 340 via display 29 to notify individuals of the emergency event. According to an exemplary embodiment, an auxiliary information display such as an NWS text message (e.g., as a closed caption display) and/or a video output from a specific channel may be provided at step 340 via display 29 under the control of processor 27.

According to another exemplary embodiment, the alert output(s) provided at step 340 may be based on the severity or alert level of the particular emergency event. For example, emergency events may be classified in one of three different alert level categories, such as statement, watch, and warning. With such a classification scheme, the alert output for an emergency event at a level 1 or statement level may be provided by an unobtrusive notification means such as a blinking LED since it is the least severe type of emergency event. The alert output for an emergency event at a level 2 or watch level may have some type of audio component (e.g., radio message). The alert output for an emergency event at a level 3 or warning level may be provided by a siren or other type of alarm since it is the most severe type of emergency event. Other types of aural and/or visual alert outputs than those expressly described herein may also be provided according to the present invention.

Turning now to FIG. 4, a flowchart 400 illustrating steps for facilitating user selection of geographical locations according to an exemplary embodiment of the present invention is shown. That is, FIG. 4 provides further details regarding item B of step 310 in FIG. 3. For purposes of example and explanation, the steps of FIG. 4 will be described with reference to environment 100 of FIG. 1 and apparatus 20 of FIG. 2. The steps of FIG. 4 are merely exemplary, and are not intended to limit the present invention in any manner.

At step 410, a user selects a first location from a list including a plurality of locations. According to an exemplary embodiment, processor 27 enables display of the list including the plurality of locations via display 29 using data stored in memory 27. An example of such a list is shown as on-screen menu 500 in FIG. 5. For purposes of example and explanation, assume that on-screen menu 500 in FIG. 5 includes a complete list of all geographical locations associated with the emergency alert function of apparatus 20. As indicated in FIG. 5, each location is represented in the list as a state and county, and includes an associated FIPS code and transmitter. From this list, the user may select the first location at step 410 by providing an input to apparatus 20 (e.g., using a remote control device not shown in FIGS.). According to an exemplary embodiment, the first location selected at step 410 corresponds to the location where the user and apparatus 20 are physically located.

At step 420, apparatus 20 identifies all transmitters 10 serving all selected locations. According to an exemplary embodiment, processor 27 identifies at least one transmitter 10 at step 420 using data stored in memory 27. Accordingly, in response to the user selecting the first location at step 410, processor 27 identifies at step 420 the particular transmitter(s) 10 that serve(s) the first location. As a first example, if the user selects Boone County, Indiana as the first location at step 410, processor 27 identifies the Indianapolis, Ind. transmitter at step 420 since this is the only transmitter serving Boone County, Indiana (see FIG. 5). As a second example, if the user selects Benton County, Indiana as the first location at step 410, processor 27 identifies the Lafayette/Yeoman, Ind. transmitter and the Crescent City, Ill. transmitter at step 420 since both of these transmitters serve Benton County, Indiana (see FIG. 5).

At step 430, apparatus 20 enables display of another list including all of the locations served by any transmitter 10 identified at step 420. According to an exemplary embodiment, processor 27 enables display of the list at step 430 via display 29 using data stored in memory 27. According to the first example described above in which the user selects Boone County, Indiana as the first location at step 410, the list displayed at step 430 includes only Decatur County, Indiana and Delaware County, Indiana since these are the only two locations served by the Indianapolis, Ind. transmitter (see FIG. 5). FIG. 6 shows an on-screen menu 600 listing these two locations in accordance with this first example. According to the second example described above in which the user selects Benton County, Indiana as the first location at step 410, the list displayed at step 430 includes only Carroll County, Indiana; Cass County, Indiana; Clinton County, Indiana; and Ford County, Illinois since these are the only four locations served by the Lafayette/Yeoman, Ind. transmitter or the Crescent City, Ill. transmitter (see FIG. 5). FIG. 7 shows an on-screen menu 700 listing these four locations in accordance with this second example.

At step 440, the user decides whether or not to select an additional location from the list displayed at step 430 (assuming at least one additional location exists). If at least one additional location exists and the user decides to select an additional location at step 440, process flow advances to step 450 where the user selects another location from the list displayed at step 430.

According to the first example described above in which the user selects Boone County, Indiana as the first location at step 410, the user may select Decatur County, Indiana or Delaware County, Indiana at step 450 (see FIG. 6). After the user selects one of these additional locations at step 450, process flow loops back to step 420 and the previously described steps may be repeated. With this first example, the user may ultimately select the remaining location (i.e., Decatur County, Indiana or Delaware County, Indiana) if step 450 is repeated again since both locations are served by the same transmitter (i.e., the Indianapolis, Ind. transmitter) as the first location selected at step 410.

According to the second example described above in which the user selects Benton County, Indiana as the first location at step 410, the user may select Carroll County, Indiana; Cass County, Indiana; Clinton County, Indiana; or Ford County, Illinois at step 450 (see FIG. 7). After the user selects one of these additional locations at step 450, process flow loops back to step 420 and the previously described steps may be repeated. With this second example, if the user selects either Carroll County, Indiana; Cass County, Indiana; or Clinton County, Indiana at step 450, the user will be precluded from later selecting Ford County, Illinois if step 450 is repeated since Ford County, Illinois is served by a different transmitter than Carroll County, Indiana; Cass County, Indiana; and Clinton County, Indiana. However, the remaining locations of Carroll County, Indiana; Cass County, Indiana; or Clinton County, Indiana may be later selected if step 450 is repeated since these locations are all served by the same transmitter (i.e., the Lafayette/Yeoman Ind. transmitter). Conversely, with this second example, if the user selects Ford County, Illinois at step 450, the user is precluded from selecting any additional locations at step 450 (i.e., no additional locations exist at step 440) since Ford County, Illinois is served by a different transmitter than Carroll County, Indiana; Cass County, Indiana; and Clinton County, Indiana.

If the user ever decides not to select an additional location at step 440 (or an additional location does not exist), process flow advances to step 460 where tuner 22 tunes a channel corresponding to the particular transmitter 10 that serves all selected locations. According to the first example described above in which the user selects Boone County, Indiana as the first location at step 410, tuner 22 tunes to a channel corresponding to 162.550 MHz (see FIG. 5) at step 460 regardless of whether any additional locations are selected at step 450 since only one transmitter (i.e., the Indianapolis, Ind. transmitter) serves Boone County, Indiana. According to the second example described above in which the user selects Benton County, Indiana as the first location at step 410, tuner 22 tunes to a channel corresponding to 162.475 MHz (see FIG. 5) at step 460 if the user selects either Carroll County, Indiana; Cass County, Indiana; or Clinton County, Indiana at step 450. Conversely, tuner 22 tunes to a channel corresponding to 162.500 MHz (see FIG. 5) at step 460 if the user selects Ford County, Illinois at step 450.

According to an exemplary embodiment, whenever tuner 22 tunes to a particular channel at step 460, processor 27 detects the signal strength on the channel and enables a predetermined message to be output if the detected signal strength is below a predetermined threshold level (which may be set as a matter of design choice). The predetermined message may, for example, instruct a user to connect a better antenna to improve signal reception. Also, if more than one transmitter 10 serves all selected locations in FIG. 4, tuner 22 may tune a channel at step 460 having the highest signal strength. This may occur with the second example described above in which the user selects Benton County, Indiana as the first location at step 410. In particular, given that Benton County, Indiana is served by two different transmitters 10 (i.e., the Lafayette/Yeoman, Ind. transmitter and the Crescent City, Ill. transmitter—see FIG. 5), if the user selects Benton County, Indiana as the first location at step 410 and decides at step 440 not to select any additional locations, tuner 22 tunes to the channel corresponding to the transmitter 10 that provides the highest signal strength at step 460. With this example, tuner 22 tunes to the stronger of the channel corresponding to 162.475 MHz (i.e., the Lafayette/Yeoman, Ind. transmitter), or the channel corresponding to 162.500 MHz (i.e., the Crescent City, Ill. transmitter).

Also according to an exemplary embodiment, users may be able to override the steps of FIG. 4 which restrict the user's selection of secondary locations for the emergency alert function. For example, a user may provide a predetermined input to apparatus 20 which thereby enables the user to select any location, even though the user may never receive notification of emergency events in those locations. Overriding the steps of FIG. 4 in this manner may, for example, be necessary if certain data stored in memory 27 becomes out of date and there is no other practical way to update such data.

As described herein, the present invention provides an apparatus and method for providing an emergency alert function that facilitates user selection of geographical locations to ensure proper notification of emergency events. The present invention may be applicable to various apparatuses, either with or without an integrated display device. Accordingly, the phrase “television signal receiver” as used herein may refer to systems or apparatuses capable of receiving and processing television signals including, but not limited to, television sets, computers or monitors that include an integrated display device, and systems or apparatuses such as set-top boxes, video cassette recorders (VCRs), DVD players, video game boxes, personal video recorders (PVRs), computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus (20) having an emergency alert function, comprising:
memory means (27) for storing data that enables a setup process of said emergency alert function;
processing means (27) for using said data to enable display of a first list including a plurality of locations;
said processing means (27) receiving a first user input selecting a first one of said locations;
said processing means (27) identifying at least one transmitter (10) serving said first location and enabling display of a second list responsive to said first user input; and
wherein said second list includes at least one of said locations served by said at least one transmitter (10) other than said first location, and does not include said locations not served by said at least one transmitter (10).

2. The apparatus (20) of claim 1, wherein:
said processing means (27) receives a second user input selecting a second one of said locations from said second list; and
said processing means (27) identifies at least one transmitter (10) serving said first and second locations responsive to said second user input.

3. The apparatus (20) of claim 2, further comprising tuning means (22) for tuning a channel corresponding to said at least one transmitter (10) serving said first and second locations.

4. The apparatus (20) of claim 3, wherein said processing means (27) detects signal strength on said channel and enables output of a predetermined message if said signal strength is below a predetermined level.

5. The apparatus (20) of claim 3, wherein:
said tuning means (22) tunes said channel to receive emergency alert signals indicating an emergency event; and
said processing means (27) enables an alert output responsive to said emergency alert signals if said emergency event corresponds to a user selected event type and at least one of said first and second locations.

6. The apparatus (20) of claim 5, wherein said first and second locations to each have an associated FIPS code.

7. A method (400) for providing a setup process for an emergency alert function of an apparatus, said method comprising steps of:
enabling display of a first list including a plurality of locations;
receiving a first user input selecting a first one of said locations (410);
identifying at least one transmitter serving said first location responsive to said first user input (420);
enabling display of a second list responsive to said first user input (430); and
wherein said second list includes at least one of said locations served by said at least one transmitter other than said first location, and does not include said locations not served by said at least one transmitter.

8. The method (400) of claim 7, further comprised of:
receiving a second user input selecting a second one of said locations from said second list (450); and
identifying at least one transmitter serving said first and second locations responsive to said second user input (420).

9. The method (400) of claim 8, further comprised of tuning a channel corresponding to said at least one transmitter serving said first and second locations (460).

10. The method (400) of claim 9, further comprised of detecting signal strength on said channel and enabling output of a predetermined message if said signal strength is below a predetermined level.

11. The method (400) of claim 9, further comprised of:
receiving emergency alert signals indicating an emergency event via said channel; and
enabling an alert output responsive to said emergency alert signals if said emergency event corresponds to a user selected event type and at least one of to said first and second locations.

12. The method (400) of claim 11, wherein said first and second locations each have an associated FIPS code.

13. A television signal receiver (20) having an emergency alert function, comprising:
a memory (27) operative to store data that enables a setup process of said emergency alert function;
a processor (27) operatively coupled to said memory, said processor (27) being operative to use said data to enable display of a first list including a plurality of locations;
said processor (27) receiving a first user input selecting a first one of said locations;
said processor (27) identifying at least one transmitter (10) serving said first location and enabling display of a second list responsive to said first user input; and
wherein said second list includes at least one of said locations served by said at least one transmitter (10) other than said first location, and does not include said locations not served by said at least one transmitter (10).

14. The television signal receiver (20) of claim 13, wherein:
said processor (27) receives a second user input selecting a second one of said locations from said second list; and
said processor (27) identifies at least one transmitter (10) serving said first and second locations responsive to said second user input.

15. The television signal receiver (20) of claim 14, further comprising a tuner (22) operative to tune a channel corresponding to said at least one transmitter (10) serving said first and second locations.

16. The television signal receiver (20) of claim 15, wherein said processor (27) detects signal strength on said channel and enables output of a predetermined message if said signal strength is below a predetermined level.

17. The television signal receiver (20) of claim 15, wherein:
said tuner (22) tunes said channel to receive emergency alert signals indicating an emergency event; and
said processor (27) enables an alert output responsive to said emergency alert signals if said emergency event corresponds to a user selected event type and at least one of said first and second locations.

18. The television signal receiver (20) of claim 17, wherein said first and second locations each have an associated FIPS code.
